(19) United States
(12) Patent Application Publication
(10) Pub. No.: US 2015/0027257 A1
(43) Pub. Date: Jan. 29, 2015

(54) BALL SCREW

(71) Applicant: TBI MOTION TECHNOLOGY CO., LTD., New Taipei City (TW)

(72) Inventors: Ching-Sheng LEE, New Taipei City (TW); Chin-Tsai YANG, New Taipei City (TW)

(73) Assignee: TBI MOTION TECHNOLOGY CO., LTD., New Taipei City (TW)

(21) Appl. No.: 14/101,331

(22) Filed: Dec. 9, 2013

(30) Foreign Application Priority Data
Jul. 25, 2013 (TW) 102214028

(51) Int. Cl. F16H 25/22

(52) U.S. Cl. CPC F16H 25/2214
USPC 74/424.86

(57) ABSTRACT

A ball screw includes a screw, a nut and a plurality of balls. The nut is slidingly disposed on the screw and includes a nut body and at least one end assembly. The end assembly includes an end circulation member, a dust-proof member and a fastening member. The fastening member and the end circulation member are disposed on the opposite sides of the dust-proof member. One side of the fastening member includes a plurality of projections, and the other side of the fastening member includes a plurality of indentations corresponding to the projections.

### CROSS REFERENCE TO RELATED APPLICATIONS

This Non-provisional application claims priority under 35 U.S.C. §119(a) on Patent Application No(s). 102214028 filed in Taiwan, Republic of China on Jul. 25, 2013, the entire contents of which are hereby incorporated by reference.

### BACKGROUND OF THE INVENTION

1. Field of Invention

The invention relates to a ball screw.

2. Related Art

The ball screw is widely applied to various kinds of mechanical devices for providing precise transmission. By the rotation and linear movement of the ball screw, the carrying stage or the object on the carrying stage can move in a linear direction.

Because the ball screw is mostly applied to the high-precision machining, it needs to achieve high-level requirement to maintain a stable and smooth operation. Besides, if an external object or liquid enters into the nut of the ball screw during the operation of the ball screw, the ball screw will generate noise, pause or lose stability and may be even damaged. In order to avoid this situation, it is necessary to dispose dust-proof structures on the two ends of the nut for preventing the external object or liquid from entering into the nut, especially, along the movement axis of the nut due to the moving force.

There are many different types for the dust-proof structure, but most of them are disposed on the two ends of the nut body of the nut and fixed to the nut body by the screws so as not to move upward along the axis of the nut. However, in the prior art, in order to make the dust-proof structure and the nut body tightly fit each other with a high precision, the more time and cost are necessary for the assembly.

Therefore, it is an important subject to provide a ball screw in which the dust-proof structure can be easily fixed due to a kind of novel design so that the assembly can be simplified and the error of the dust-proof structure or nut body caused by the machining can be reduced.

### SUMMARY OF THE INVENTION

In view of the foregoing subject, an objective of the invention is to provide a ball screw in which the dust-proof structure can be easily fixed due to a kind of novel design so that the assembly can be simplified and the error of the dust-proof structure or nut body caused by the machining can be reduced.

To achieve the above objective, a ball screw according to the invention comprises a screw, a nut and a plurality of balls. The screw includes at least two track grooves. The nut is slidingly disposed on the screw and includes a nut body and at least one end assembly. The nut body has two assembly openings. The inside of the nut body includes at least two inner ball grooves corresponding to the track grooves, respectively, the inner ball grooves and the track grooves constitute two inner ball channels, the nut body includes two reflowing channels corresponding to the inner ball channels, and the reflowing channels and the inner ball channels constitute a part of two ball circulation channels of the ball screw. The end assembly includes an end circulation member, a dust-proof member and a fastening member. The end circulation member is disposed to the nut body and includes at least two circulation portions which are disposed in the assembly openings, respectively. The dust-proof member is disposed on the side of the end circulation member away from the nut body. The fastening member is disposed on the side of the dust-proof member away from the end circulation member. One side of the fastening member includes a plurality of projections and the other side of the fastening member includes a plurality of indentations corresponding to the projections. The balls are disposed within the ball circulation channels.

In one embodiment, the projections and the indentations are projected and concaved along the lengthwise direction of the nut body, respectively.

In one embodiment, the fastening member is compressible or deformable along the lengthwise direction of the nut body.

In one embodiment, one end of the nut body includes a first annular containing recess and a second annular containing recess, the end circulation member is disposed in the first annular containing recess, and the dust-proof member and the fastening member are disposed in the second annular containing recess.

In one embodiment, the axial thicknesses of the dust-proof member and the fastening member are greater than the axial thickness of the second annular containing recess.

In one embodiment, the inner diameter of the second annular containing recess is greater than that of the first annular containing recess.

In one embodiment, the material of the dust-proof member is a flexible material, and the material of the fastening member is a rigid material.

In one embodiment, the projections are connected continuously.

In one embodiment, a plurality of the intervals exist among the projections, and the projections are not continuous.

In one embodiment, the projections are arched, convex or taper.

In one embodiment, the dust-proof member is composed of a plurality of dust-proof units.

In one embodiment, a strengthening member is disposed in each of the circulation portion.

As mentioned above, the ball screw of the invention is designed in an innovative way so that the fastening member of the end assembly for fastening the dust-proof member is compressible, and therefore the precision requirement of the ball screw can be reduced and the assembly speed can be increased. Besides, by the disposition of the fastening member, the displacements of all the components will not occur even after a long time usage of the ball screw. In comparison with the prior art, the dust-proof member is fastened within the annular containing recess of the ball screw by the fastening member, so the tolerances of the dust-proof member and the annular containing recess can be both allowed, and therefore the manufacturing process can be made easier and the cost can be lowered down.

On the whole, due to the innovative design of the structure, the ball screw can be made by a simpler machining, and this not only reduces the difficulty and time of the machining but also absorbs the tolerance of the dust-proof member or nut body.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a ball screw according to a preferred embodiment of the invention;

FIG. 2 is a schematic exploded diagram of the ball screw in FIG. 1;

FIG. 3 is a schematic sectional diagram of a part of the ball screw in FIG. 1;

FIG. 4A is a schematic diagram of the nut body in FIG. 2;

FIG. 4B is a schematic sectional diagram taken along the line A-A in FIG. 4A;

FIG. 5A is a schematic enlarged diagram of the fastening member of the ball screw in FIG. 2;

FIG. 5B is a schematic side view of the fastening member in FIG. 5A;

FIG. 6 is a schematic enlarged diagram of a variation of the fastening member of the ball screw according to an embodiment of the invention; and

FIG. 7 is a schematic enlarged diagram of a variation of the fastening member of the ball screw according to an embodiment of the invention.

### DETAILED DESCRIPTION OF THE INVENTION

The present invention will be apparent from the following detailed description, which proceeds with reference to the accompanying drawings, wherein the same references relate to the same elements.

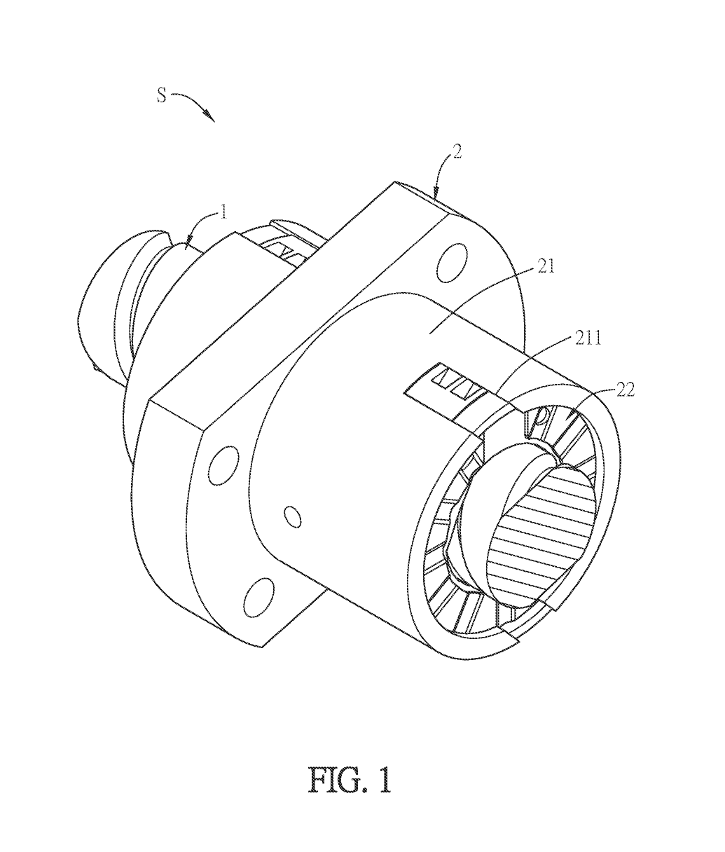

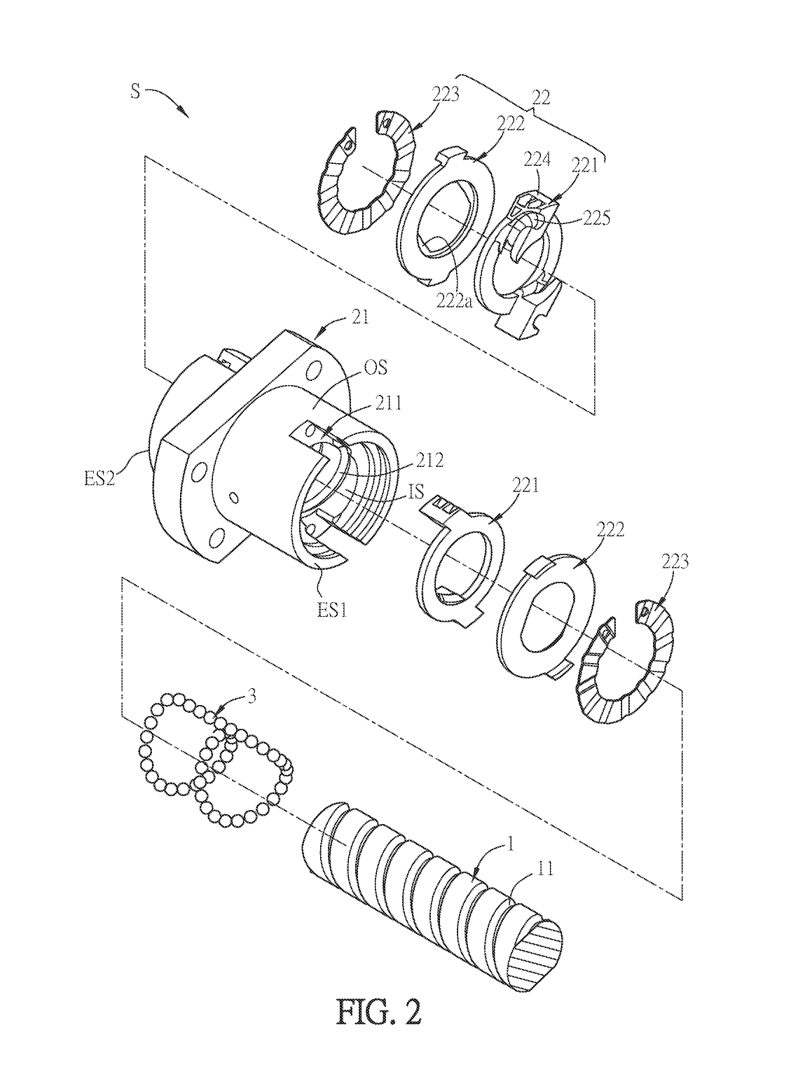

FIG. 1 is a schematic diagram of a ball screw according to a preferred embodiment of the invention, and FIG. 2 is a schematic exploded diagram of the ball screw in FIG. 1. As shown in FIGS. 1 and 2, the ball screw S includes a screw 1, a nut 2 and a plurality of balls 3. The screw 1 is a cylindrical shaft, and a spiral track groove 11 winds around the longitudinal axis (i.e. the lengthwise axis of the screw 1) on the outer surface of the screw 1. The nut 2 is slidingly disposed on the screw 1, and includes a nut body 21 and at least one end assembly 22. In this embodiment, there are two sets of end assembly 22 for example. The nut body 21 is a hollow pillar approximately so that the screw 1 can pass through the nut body 21. The nut body 21 further includes an assembly opening 211 which the end assembly 22 is disposed through. Besides, the inside of the nut body 21 is configured with at least two inner ball grooves 212 corresponding to the track groove 11. The below is the illustration about the structural features and members of the ball screw S.

In this embodiment, the nut body 21 is obtained by processing a nut body material (not shown). Physically, the nut body material can be a metal piece or pillar, and is formed into the nut body 21 with its detailed structure by a grinding process. Of course, the nut body 21 can be formed by other kinds of processes. For example, the nut body 21 can be made by casting molding, forge forming, or turning and milling machining The nut body 21 can be an annular pillar and the inside thereof is configured with the inner ball groove 212. In other embodiments, some functional structure, such as a flange hole, oil filler hole or reflowing hole, can be disposed on the nut body according to the practical requirements, and even the nut body can undergo a surface heat treatment to obtain the enhanced hardness. However, the invention is not limited thereto.

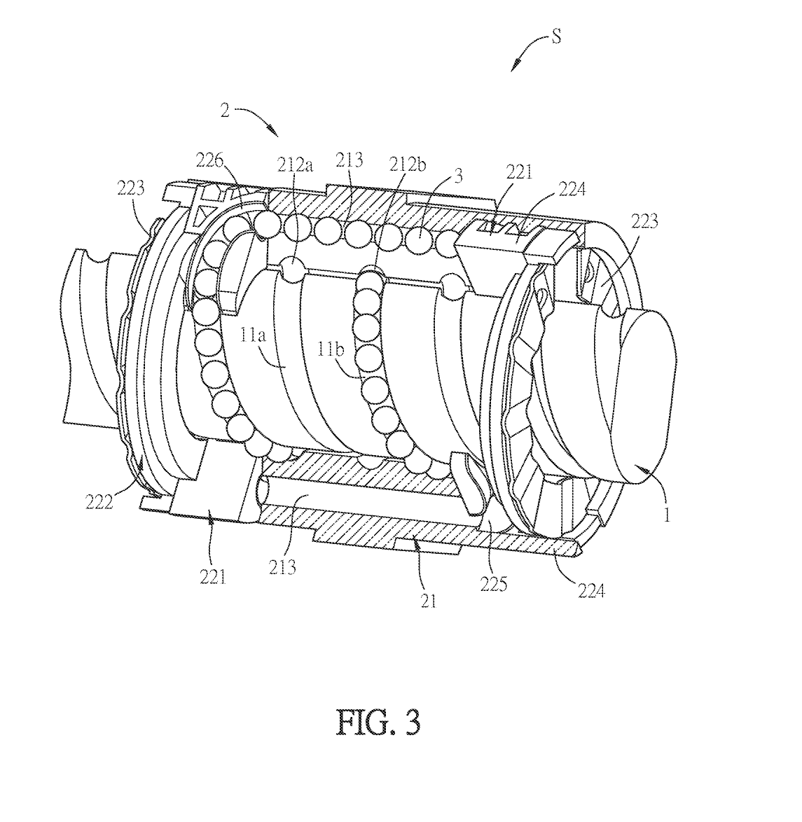

FIG. 3 is a schematic sectional diagram of a part of the ball screw in FIG. 1. As shown in FIGS. 2 and 3, the ball screw S is a double-threaded ball screw for example, and that means the ball screw S has two independent ball circulation channels. In detail, the track groove 11 consists of two track grooves 11a and 11b individually formed on the outer surface of the screw 1, and the inside of the nut body 21 is configured with two inner ball grooves 212a and 212b corresponding to the track grooves 11a and 11b, respectively. The pitch and groove form of the inner ball grooves 212a and 212b are the same as or similar to those of the track grooves 11a and 11b. When the screw 1 passes through the nut 2, the inner ball grooves 212a and 212b correspond to the track grooves 11a and 11b to constitute two inner ball channels. The nut body 21 includes two reflowing channels 213 corresponding to the inner ball channels, and the reflowing channels 213 and the inner ball channels constitute a part of the two ball circulation channels of the ball screw S for providing circulating moving paths for the balls 3.

As shown in FIGS. 2 and 3, in this embodiment, the nut 2 includes two sets of end assembly 22 for enhancing the whole functionality. The end assembly 22 includes an end circulation member 221, a dust-proof member 222 and a fastening member 223. Favorably, the end assembly 22 and the nut body 21 are assembled by an engaging way.

In detail, for the assembly, the end circulation member 221 of the end assembly 22 is engaged at the assembly opening 211 of the nut body 21, and the other members of the end assembly 22 are contained and engaged in a containing recess. Furthermore, the end circulation member 221 includes two circulation portions 224, which are disposed at the assembly opening 211. The circulation portion 224 further includes a reflowing curve 225, which communicates with the reflowing channel 213 of the nut body 21 and the inner ball channel to collectively constitute the two ball circulation channels of the ball screw S.

Accordingly, in a whole sense, the inner ball channel and the reflowing channel 213 complete the ball circulation channel by the reflowing curve 225. The balls 3 are disposed in the ball circulation channels and roll frontward to drive the nut 2 to move relative to the screw 1.

In this embodiment, because the ball 3 causes a force to the reflowing curve 225 when passing through the reflowing curve 225, a strengthening member 226 is disposed in the reflowing curve 225 to intensify its strength. The material of the strengthening member 226 is not limited, and can be, for example, stainless steel with a high impact-resistant property or other kinds of metal material.

As shown in FIGS. 2 and 3, the assembly opening 211 is extended from a first end surface ES1 to a second end surface ES2 and communicates with an outer surface OS and an inner surface IS of the nut body 21, acting an open-type breach on the nut body 21. Therefore, in the manufacturing process, just a milling operation by a lathe (especially a CNC turning and milling device) as an open-type machining is performed to cut a piece of a predetermined size from the first end surface ES1 to the second end surface ES2 or from the outer surface OS to the inner surface IS to form the assembly opening 211. In other embodiments, the assembly opening 211 also can be formed by a turning work or cutting work for example. Besides, after the assembly opening 211 is formed, the burr of the assembly opening 211 can be removed by a grinding and/or polishing machining and thus the tolerance can be reduced. However, the invention is not limited thereto. Moreover, other portions of the operation not illustrated in the above should be considered the art that can be comprehended by those skilled in the art, and therefore they are not described here for conciseness.

To be noted, because the assembly opening 211 can be made by an open-type machining and communicate with the outer surface and inner surface, the detection thereof will be easier and the detection tools for the quality control operation will be simpler. For example, the precision of the product can be assured just by a two-dimensional detection, and this will shorten the manufacturing process or quality control process and lower down the cost, in comparison with the prior art. On the whole, the nut body 21 with the assembly opening 211 of the embodiment, in comparison with the prior art, can be made by an open-type machining due to the particular structural design, so the machining difficulty and time can be both reduced and the precision of the assembly opening 211 can be enhanced a lot.

In this embodiment, the double-threaded ball screw S includes the two ball circulation channels which can contain two independent sets of the balls 3. When the balls 3 move within the two ball circulation channels, the nut 2 will rotate around the axis of the screw 1 so that the rotating movement can be converted into the linear movement. To be noted, although only one set of the balls 3 is shown in the figures for the purpose of clarity, the operation manner and related technology of the two sets of the balls 3 can be comprehended by those skilled in the art. To be noted, a triple-threaded or multiple-threaded ball screw can be used in other embodiments, and the track grooves, inner ball grooves, assembly opening and reflowing channels can be formed accordingly with a corresponding number.

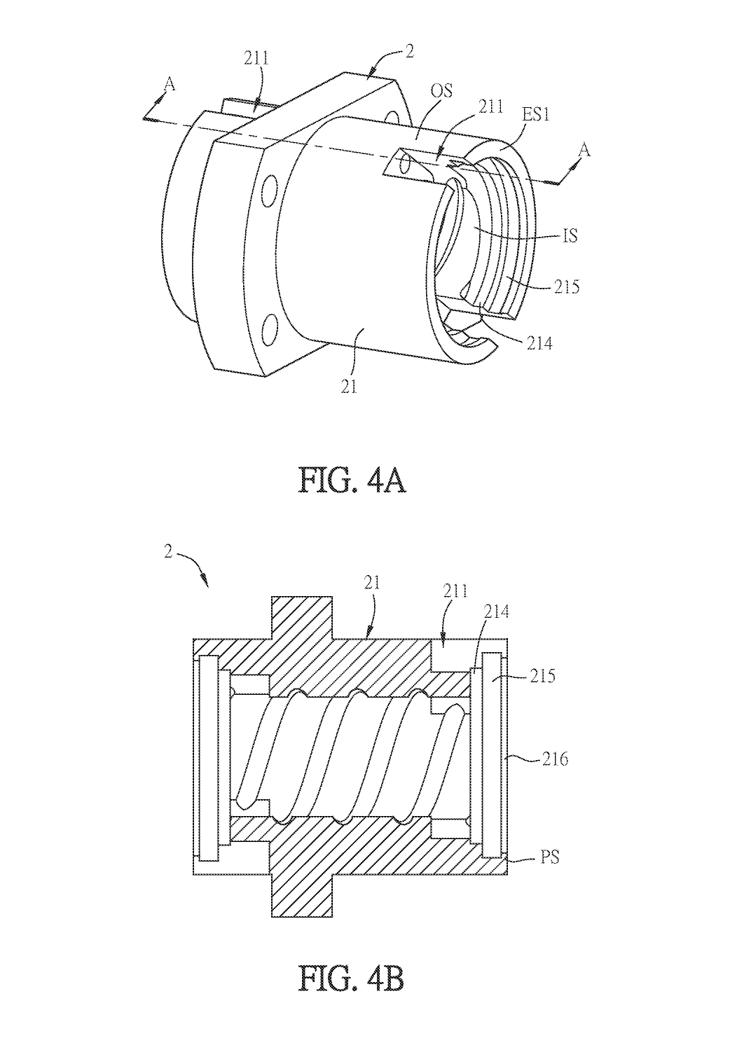

As shown in FIG. 3, the dust-proof member 222 is disposed on the side of the end circulation member 221 away from the nut body 21, and the fastening member 223 is disposed on the side of the dust-proof member 222 away from the end circulation member 221. Favorably, as shown in FIGS. 4A and 4B, one end of the nut body 21 sequentially has a first annular containing recess 214, a second annular containing recess 215 and an annular recess 216, from inside to outside. The first annular containing recess 214 and the second annular containing recess 215 are formed within the nut body 21, and the annular recess 216 is defined from the nut body 21 to the inner protrusion PS. To be noted, due to the orientation of cross-section, a part of FIG. 4B shows the assembly opening 211 and just a part of the protrusion PS is shown in FIG. 4B.

As shown in FIGS. 2, 3, 4A and 4B, the end circulation member 221 is contained by the first annular containing recess 214, and the dust-proof member 222 and the fasting member 223 are both contained by the second annular containing recess 215. In this embodiment, the material of the dust-proof member 222 is a flexible material, and therefore the dust-proof member 222 can absorb the tolerance of the assembly due to the flexibility and can provide the effects of dust-proof and oil seal.

Accordingly, the fastening member 223 is disposed on the outermost side relative to the nut body 21 and contained by the second annular containing recess 215. The fastening member 223 favorably has a C-type structure. In the assembly, the fastening member 223 can be compressed by the external force so as to be decreased in volume, and thus can pass through the annular recess 216, as shown in FIG. 1 or 4B, to be disposed within the second annular containing recess 215. Afterward, the fastening member 223 can be expanded to press the second annular containing recess 215 due to the recovery force of itself. Thereby, the end assembly 22 is fastened along the lengthwise direction of the screw 1. Therefore, the longitudinal movement of the end assembly 22 can be avoided.

In this embodiment, the axial thicknesses of the dust-proof member 222 and the fastening member 223 are greater than the axial thickness of the second annular containing recess 215. However, the invention is not limited thereto, and the practical condition can be adjusted according to the requirements of the process and the usage of the ball screw.

Accordingly, because the nut body 21 has the assembly opening 211 for linking the end assembly 22 and the end assembly 22 includes the fastening member 223, the displacement of the nut body 21 and the end assembly 22 can be avoided even when they are connected to each other without any screw. To be noted, in other embodiments, if the ball screw is a small-type ball screw or has no space for the usage of screws for the connection, the better effect can be provided by using the above-mentioned structure.

The dust-proof member can be composed of at least a dust-proof unit. In this embodiment, as shown in FIG. 2, the dust-proof member 222 is composed of a single dust-proof unit. However, the invention is not limited thereto. For example, the dust-proof member can include a plurality of dust-proof units, and the number of the dust-proof units is determined according to the level of the dust-proof requirement. The dust-proof unit is an annular structure, and its hollow portion is not a regular circle but has a brush portion 222a extended at the inner edge of the dust-proof unit. The brush portion 222a also can be called a tongue portion because it is shaped like a tongue. The brush portion 222a is disposed at the place corresponding to the track recess 11 so as to tightly fit the track recess 11 for scraping or brushing the dust or undesired objects on the track recess 11 or avoiding the dust or undesired objects from entering through the gap of the track recess 11. Favorably, as shown in FIGS. 4A and 4B, the inner diameter of the second annular containing recess 215 is greater than that of the first annular containing recess 214, so the inside of the nut body 21 near the first end surface ES1 forms a ladder-like structure. Thereby, it is more difficult for the dust or undesired objects to enter into the inside of the nut body 21 when the dust-proof member 222 is disposed within the second annular containing recess 215 having the larger inner diameter, and therefore the dust-proof effectiveness is further enhanced.

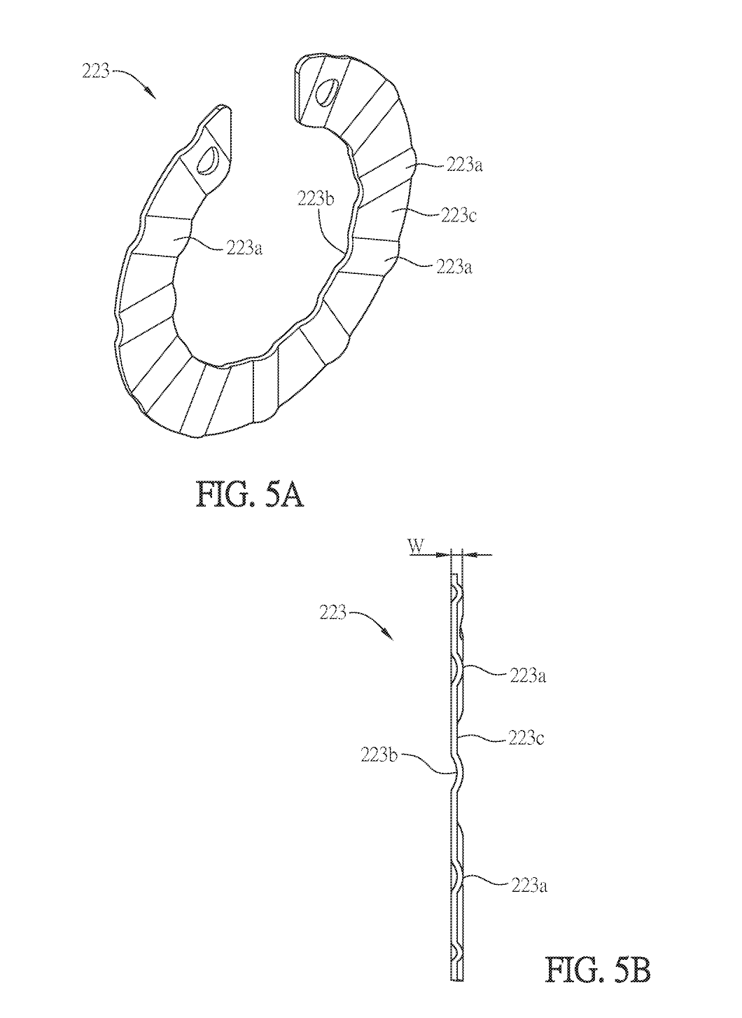

Furthermore, the fastening member includes a plurality of projections, as a technical feature. FIG. 5A is a schematic enlarged diagram of the fastening member of the ball screw in FIG. 2, and FIG. 5B is a schematic side view of the fastening member in FIG. 5A. As shown in FIGS. 5A and 5B, in this embodiment, at least one side of the fastening member 223 away from the nut body 21 has a plurality of projections 223a, and a plurality of intervals 223c exist between or among the projections 223a so that the projections 223a become unconnected. The other side of the fastening member 223 has a plurality of indentations 223b corresponding to the projections 223a. Due to the projections and indentations, the fastening member 223 is sun-shaped or wave-shaped in a whole sense, so it also can be called a sun sheet or wave sheet.

Because the fastening member 223 includes projections 223a and indentations 223b which correspond to each other, the fastening member 223 can have the largest thickness W with the relatively smaller wall thickness, since the thickness W of the fastening member 223 is defined according to the farthest distance thereof away from the screw. Besides, the projections 223a and the indentations 223b can be projected or concaved along the lengthwise direction of the nut body 21, and that means the fastening member 223 is compressible or deformable along the lengthwise direction of the nut body 21. Therefore, the fastening member 223 can be slightly compressed to be fit within the second annular containing recess 215, and this effectively absorb the tolerance of the nut 2 caused during the machining Therefore, the purpose of fastening the dust-proof member 222 can be achieved.

Because the fastening structure used in the prior art can not be compressed, the assembly precision of the ball screw is demanded to be higher. In contrast to the prior art, the fastening member 223 of the invention can be compressed, so the requirement of the assembly precision of the ball screw can be reduced, and therefore the manufacturing process can be simplified, the assembly speed can be increased and the cost can lowered down. Moreover, by the disposition of the fastening member 223, the displacements of all the components will not occur even after a long time usage of the ball screw S.

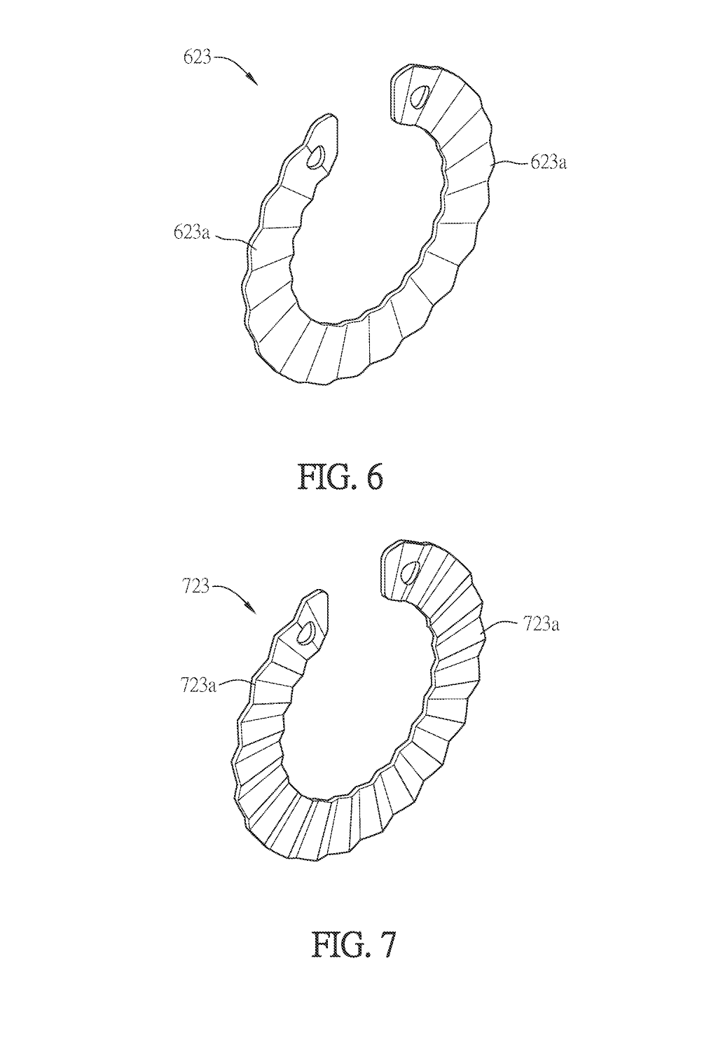

The projections can be embodied otherwise, and for example, the fastening member can have a plurality of continuous projections. As shown in FIG. 6, all the projections 623a of the fastening member 623 are connected continuously, so that the compressible effect of the fastening member 623 is enhanced and the assembly speed and easiness are both increased.

The shape of the projection is not limited in this invention. For example, in the embodiment of FIG. 7, the projection 723a of the fastening member 723 has a taper shape. In other embodiments, the projection can be shaped otherwise.

In summary, the ball screw of the invention is designed in an innovative way so that the fastening member of the end assembly for fastening the dust-proof member is compressible, and therefore the precision requirement of the ball screw can be reduced and the assembly speed can be increased. Besides, by the disposition of the fastening member, the displacements of all the components will not occur even after a long time usage of the ball screw. In comparison with the prior art, the dust-proof member is fastened within the annular containing recess of the ball screw by the fastening member, so the tolerances of the dust-proof member and the annular containing recess can be both allowed, and therefore the manufacturing process can be made easier and the cost can be lowered down.

On the whole, due to the innovative design of the structure, the ball screw can be made by a simpler machining, and this not only reduces the difficulty and time of the machining but also absorbs the tolerance of the dust-proof member or nut body.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A ball screw, comprising:
a screw including at least two track grooves;
a nut slidingly disposed on the screw and including:
a nut body having two assembly openings, wherein the inside of the nut body includes at least two inner ball grooves corresponding to the track grooves, respectively, the inner ball grooves and the track grooves constitute two inner ball channels, the nut body includes two reflowing channels corresponding to the inner ball channels, and the reflowing channels and the inner ball channels constitute a part of two ball circulation channels of the ball screw; and
at least one end assembly, including:
an end circulation member disposed to the nut body and including at least two circulation portions which are disposed in the assembly openings, respectively;
a dust-proof member disposed on the side of the end circulation member away from the nut body; and
a fastening member disposed on the side of the dust-proof member away from the end circulation member, wherein one side of the fastening member includes a plurality of projections and the other side of the fastening member includes a plurality of indentations corresponding to the projections; and
a plurality of balls disposed within the ball circulation channels.

2. The ball screw as recited in claim 1, wherein the projections and the indentations are projected and concaved along the lengthwise direction of the nut body, respectively.

3. The ball screw as recited in claim 1, wherein the fastening member is compressible or deformable along the lengthwise direction of the nut body.

4. The ball screw as recited in claim 1, wherein one end of the nut body includes a first annular containing recess and a second annular containing recess, the end circulation member is disposed in the first annular containing recess, and the dust-proof member and the fastening member are disposed in the second annular containing recess.

5. The ball screw as recited in claim 4, wherein the axial thicknesses of the dust-proof member and the fastening member are greater than the axial thickness of the second annular containing recess.

6. The ball screw as recited in claim 4, wherein the inner diameter of the second annular containing recess is greater than that of the first annular containing recess.

7. The ball screw as recited in claim 1, wherein the material of the dust-proof member is a flexible material, and the material of the fastening member is a rigid material.

8. The ball screw as recited in claim 1, wherein the projections are connected continuously.

9. The ball screw as recited in claim 1, wherein a plurality of the intervals exist among the projections, and the projections are not continuous.

10. The ball screw as recited in claim 8, wherein the projections are arched, convex or taper.

11. The ball screw as recited in claim 9, wherein the projections are arched, convex or taper.

12. The ball screw as recited in claim 1, wherein the dust-proof member is composed of a plurality of dust-proof units.

13. The ball screw as recited in claim 1, wherein a strengthening member is disposed in each of the circulation portion.
